(19) United States
(12) Patent Application Publication
(10) Pub. No.: US 2026/0291158 A1
(43) Pub. Date: Sep. 24, 2026

(54) CURRENT COLLECTOR

(71) Applicant: Conductix-Wampfler GmbH, Weil am Rhein (DE)

(72) Inventor: Dieter SEIDEL, Steinen (DE)

(73) Assignee: Conductix-Wampfler GmbH, Weil am Rhein (DE)

(21) Appl. No.: 19/474,802

(22) PCT Filed: Jan. 22, 2024
(86) PCT No.: PCT/EP2024/051420

§ 371 Date: Oct. 13, 2025

(30) Foreign Application Priority Data
Apr. 14, 2023 (DE) 10 2023 109 496.3

(51) Int. Cl. H01R 31/06; H01R 13/24; H01R 13/627; H01R 25/14; H01R 41/00

(52) U.S. Cl. CPC H01R 31/06; H01R 13/2407; H01R 13/2492; H01R 13/6278; H01R 25/142; H01R 41/00

(57) ABSTRACT

A current collector, in particular for supplying electrical energy and/or data to an electrical consumer, which is movable along a conductor line addresses the problem of providing a current collector that enables simple, rapid, and tool-free changing or replacement of contacts, by means of a current collector with a base part and an interchangeable part which is releasably connectable to the base part. The interchangeable part has at least one first electrically conductive contact for electrically contacting an electrically conductive counter-contact. The base part has an electrical connecting contact and the interchangeable part has an electrical connecting counter-contact, which is electrically connectable to the electrical connecting contact.

### FIELD OF THE INVENTION

The invention relates to a current collector, in particular for supplying electrical energy and/or data to an electrical consumer, which is movable along a conductor line.

### BACKGROUND OF THE INVENTION

The current collector mentioned in the introduction has long been known. DE 20 2016 105 157 U1 discloses a current collector for an electrical consumer with at least one sliding contact support or a sliding contact for contacting at least one electrically conductive conductor profile of a conductor line, the sliding contact being connectable in an electrically conductive manner to an electrical connection of the electrical consumer. When the sliding contacts are worn, they must be replaced by maintenance personnel. Ordinarily, the cable connections must also be disconnected and reconnected, which requires experienced technical personnel and is time-consuming, thus resulting in long downtimes.

DE 16 13 919 A relates to a current collector with a current collector housing, which consists of a single piece of insulation material, wherein an elongated recess is formed in the top of the housing to accommodate the lower part of a contact shoe. Two spaced-apart flexible gripping jaws extend upward from the base of the recess, which engage the lower part of the contact shoe. The upper parts of the insides of the gripping jaws and the side walls of the contact shoe are formed with intermeshing protrusions and grooves so that the contact shoe is held in the recess. When the contact shoe is inserted, the gripping jaws are moved outward slightly until the protrusions and grooves correspond to each other. The gripping jaws spring inward in this position so that the contact shoe is secured in the current collector housing. The current collector housing therefore has no metal parts since it consists of a single piece and the contact shoe can be easily replaced. The contact shoe also contacts a current rail on one side and an electrical conductor of the current collector housing on the other side, which is connectable to the lower part of the contact shoe by means of a U-shaped clamping device.

### SUMMARY OF THE INVENTION

One aspect of the invention therefore relates to a current collector that enables simple, rapid, and tool-free replacement or exchange of contacts.

The invention addresses this problem by means of a current collector as disclosed herein. Advantageous embodiments and expedient modifications of the invention are also disclosed herein.

The current collector according to the invention has a base part and an interchangeable part which is releasably connectable to the base part, wherein the interchangeable part has at least one first electrically conductive contact for electrically contacting an electrically conductive counter-contact, wherein the base part has an electrical connecting contact and the interchangeable part has an electrical connecting counter-contact, which is electrically connectable to the electrical connecting contact.

A connection, in particular a quick-change connection, can preferably be provided for releasable connection of the base part to the interchangeable part, wherein at least one connecting element is provided on the base part and at least one corresponding connecting counter-element on the interchangeable part.

An additional connecting counter-element can advantageously be arranged on the interchangeable part, in particular on a side of the interchangeable part opposite the first connecting counter-element. An additional connecting element can also preferably be arranged on the base part, in particular on a side of the base part opposite the first connecting element. The connection can advantageously be a plug connection, in particular a dovetail connection. The connection can preferably extend into the base part in an insertion direction of the interchangeable part. In an advantageous embodiment, the connection can have a pin arranged on the base part, which extends through a channel running fully or at least partially through the interchangeable part.

A locking device can be provided for preferably manually releasable locking of the interchangeable part on the base part. The locking device can advantageously have a locking opening on the base part and a locking pin on the interchangeable part, which can be inserted into the locking opening, in which a moveable locking lug on the one part can be inserted into a locking stop on the other part and locked therein. The locking pin can also form the connection and the locking bore the channel of the quick-change connection described above and below.

The first contact can preferably be pressed in the direction of the counter-contact by means of a pressure element arranged on the interchangeable part.

In addition, a second contact, which forms the electrical connecting counter-contact, can advantageously be provided on a side of the interchangeable part opposite the first contact, in particular opposite the first contact. The first contact and the second contact can preferably be formed as independent parts separate from each other.

The first contact and the second contact can preferably be electrically connected to each other.

When the interchangeable part is connected to the base part, the first contact can then advantageously be connectable to a first protective contact, in particular a protective contact pin of the base part, and the second contact can be connected to a second protective contact pin on the base part, wherein the first and second protective contact pins are electrically connected to each other in or on the base part.

The second contact can also be advantageously pressed by an additional pressure element from the interchangeable part in the direction of the connecting contact of the base part. The additional pressure element can also be formed by the pressure element described above and below. In this respect, the one pressure element thus has a dual function for both contacts. An opening can preferably be provided in the base part and the corresponding additional extraction opening in the interchangeable part for extracting abraded material from the contact or contacts of the interchangeable part.

The interchangeable part can also preferably have a housing, wherein the contact or contacts are arranged in the housing and extend outward through a connecting counter-contact opening or contact opening in the housing for contacting with the counter-contact and/or the connecting contact of the base part. The contact or contacts can each have at least one stop abutting the housing in order to preferably prevent the contact or contacts from falling out of the corresponding connecting counter-contact openings or contact openings.

The connecting contacts, the connecting counter-contacts and/or the contacts can preferably be aligned in an insertion direction of the interchangeable part into the base part.

The connecting counter-contacts and/or the contacts can preferably be arranged in channel-shaped recesses of the interchangeable part preferably extending over the entire length of the interchangeable part.

The interchangeable part can advantageously have viewing openings for wear indicators connected to the connecting counter-contacts and/or contacts, which indicate the degree of wear of the connecting counter-contacts and/or contacts.

Preferably, a release device can be provided, which disconnects the connecting contacts from the voltage when the locking mechanism is opened. Furthermore, when the locking mechanism is opened, the release device can disconnect the electrical connection between the connecting contacts and an electrical connection line.

The current collector can preferably be provided for fastening to a movable electrical consumer. The connecting contact of the base part can then be connectable or connected to an electrical connection line of the electrical consumer.

The first contact can preferably be a sliding contact, the second contact a second sliding contact and/or the counter-contact a conductor line profile of a conductor line, along which the consumer can be moved in a longitudinal direction of the conductor line.

The counter-contact can also be a charging contact of a stationary electrical charging station and the current collector can be arranged on a movable electrical consumer. As an alternative the counter-contact can be a charging contact of a movable electrical consumer, and the current collector is arranged on a fixed electrical charging station.

An alternative current collector has a base part provided for attachment to a an electrical consumer that can be moved along a conductor line in its longitudinal direction, and an interchangeable part releasably connectable to the base part, the interchangeable part having at least one first sliding contact for electrically contacting an electrically conductive line profile of the conductor line, the base part having an electrical connecting contact and the interchangeable part having an electrical connecting counter-contact electrically connectable to the electrical connecting contact, and the connecting contact of the base part being connectable to an electrical connection line of the electrical consumer.

### BRIEF DESCRIPTION OF THE DRAWINGS

Additional details and advantages of the invention are apparent from the following description of a preferred exemplary embodiment, with reference to the drawings. In the drawings:

FIG. 1 shows a schematic three-dimensional view of a current collector according to the invention with a separate base part and interchangeable part;

FIG. 1A shows a section through the current collector of FIG. 1 in the longitudinal direction and parallel to the sliding contacts of the interchangeable part, with the interchangeable part in a partially retracted state;

FIG. 1B shows a section through the current collector of FIG. 1A with the interchangeable part in the finally installed state, in the longitudinal direction and parallel to the sliding contacts of the interchangeable part;

FIG. 2 shows a schematic three-dimensional view of the current collector of FIG. 1 from the top right in FIG. 1;

FIG. 3 shows a schematic three-dimensional view of the current collector of FIG. 2 with a view of the interchangeable part from below;

FIG. 4 shows a schematic three-dimensional view of a current collector according to FIG. 1 with an alternative first quick-change connection;

FIG. 5 shows a schematic three-dimensional view of the current collector of FIG. 4 according to the illustration in FIG. 2 with an alternative first quick-change connection;

FIG. 6 shows a schematic three-dimensional view of a current collector according to FIG. 2 with an alternative first quick-change connection;

FIG. 7 shows a schematic three-dimensional view of a current collector according to FIG. 2 with an alternative second quick-change connection;

FIG. 8 shows a schematic three-dimensional view of a current collector according to FIG. 2 with an alternative third quick-change connection.

### DETAILED DESCRIPTION

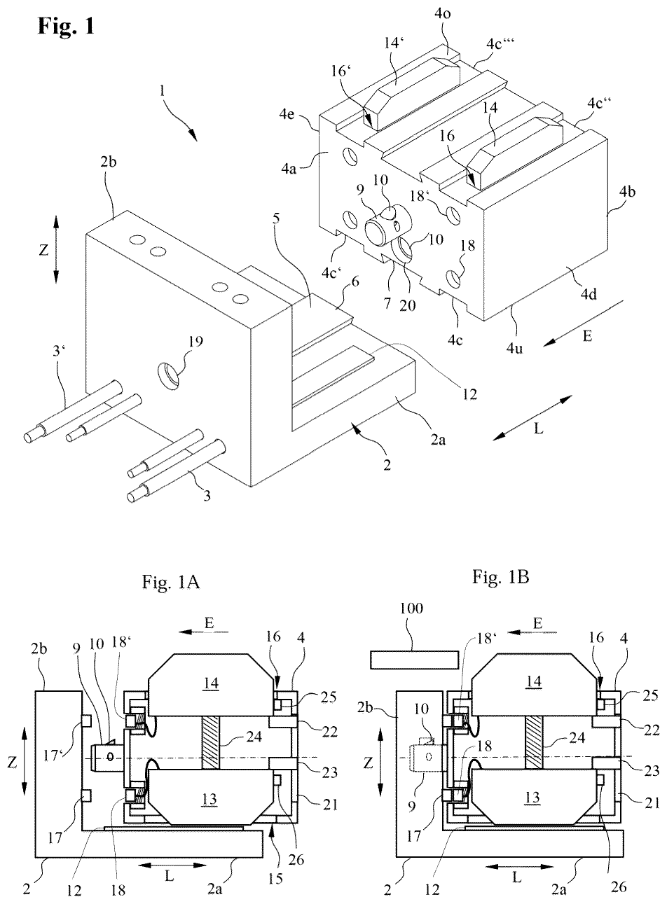

FIG. 1 shows a current collector 1 with a base part 2, which can be electrically connected to electrical connection lines 3, 3′ of an electrical consumer (not shown), to which the base part 2 is fastened. The current collector 1 can be moved in known fashion in its longitudinal direction L along a conductor line 100 shown only in FIG. 1B, in order to supply the electrical consumer with electrical energy from the conductor line 100. Such a configuration is thoroughly familiar to one skilled in the art.

In order to electrically connect the electrical consumer via the base part 2 to a conductor line profile of conductor line 100 not shown in the drawing, an interchangeable part 4 is additionally provided. The interchangeable part 4 can be quickly connected to the base part 2 via a quick-change connection 5 arranged in a connection section 2a of the interchangeable part 4, here in the form of a dovetail connection. For this purpose, the connection section 2a of the base part 2 has a connecting element 6 of the dovetail connection, in which a first connecting counter-element 7 of the dovetail connection provided on the interchangeable part 4 can be pushed in an insertion direction E. The interchangeable part 4 can therefore be quickly connected to the base part 2 or removed. The configuration of the connecting element 6 and the connecting counter-element 7 can also be swapped.

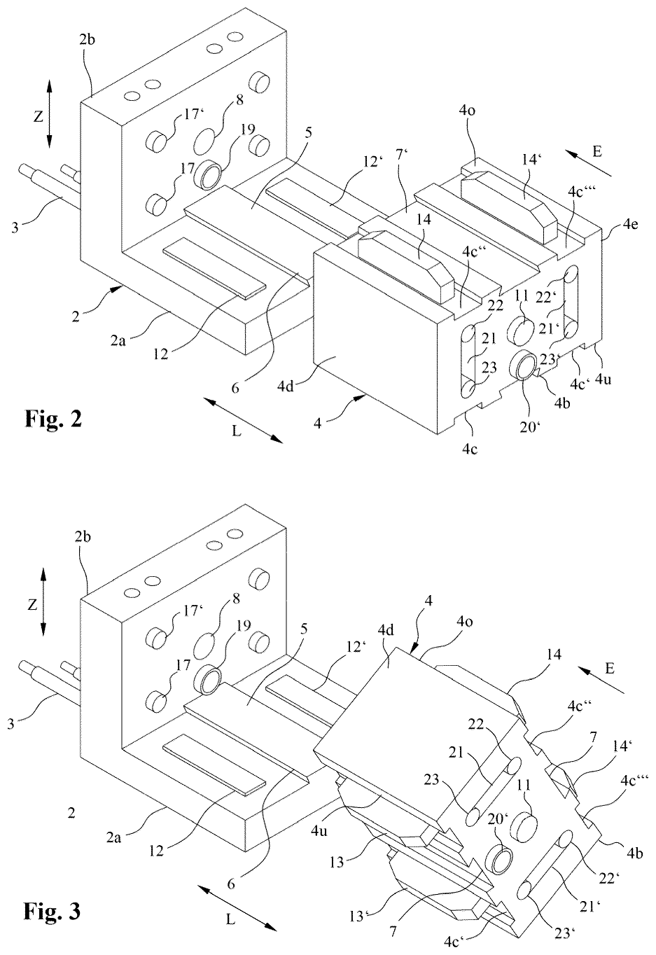

In order to be able to releasably connect the interchangeable part 4 to the base part 2 firmly during operation and for maintenance and replacement, a locking bore 8, which can be seen in FIG. 2, is provided in a face 2b in the base part 2, which is angled in an L-shape relative to the connection section. The face 2b then also serves as a stop for the interchangeable part 4. A locking pin 9, which protrudes from a face 4a of the interchangeable part 4 running across the insertion direction, can engage in the locking bore 8 when the interchangeable part 4 is pushed onto the base part 2. The locking pin 9 is designed hollow here and has a locking lug 10 on its end engaging in the locking bore 8, which can be moved radially outward from its interior into a radial bore in the locking pin 9. In the normal state, the locking lug 10 is pressed by spring action radially outward. Since the locking lug 10 is wedge-like and inclined forward in the direction of insertion into the locking bore 8, the locking lug 10 is initially pressed downward against the spring force during insertion and then snaps into the locking bore 8 upon reaching an undercut provided in the locking bore 8 for this purpose. In order to release the now locked connection, according to FIG. 2, a locking button 11 is provided on a face 4b of the interchangeable part 4 opposite the face 4a on the base side. If the locking button 11 is pressed, the locking lug 10 is lowered into the locking pin and the interchangeable part 4 can be removed from the base part 2.

The locking mechanism formed by the locking bore 8, the locking pin 9, the locking lug 10 and the locking button 11 can also be configured differently, for example, a pin can be provided, which is arranged in the face 2b of the face part 2, and which engages in the locking bore 8 from the top, which pin can then be inserted into a corresponding bore of the locking pin 9 in the inserted state of the interchangeable part 4.

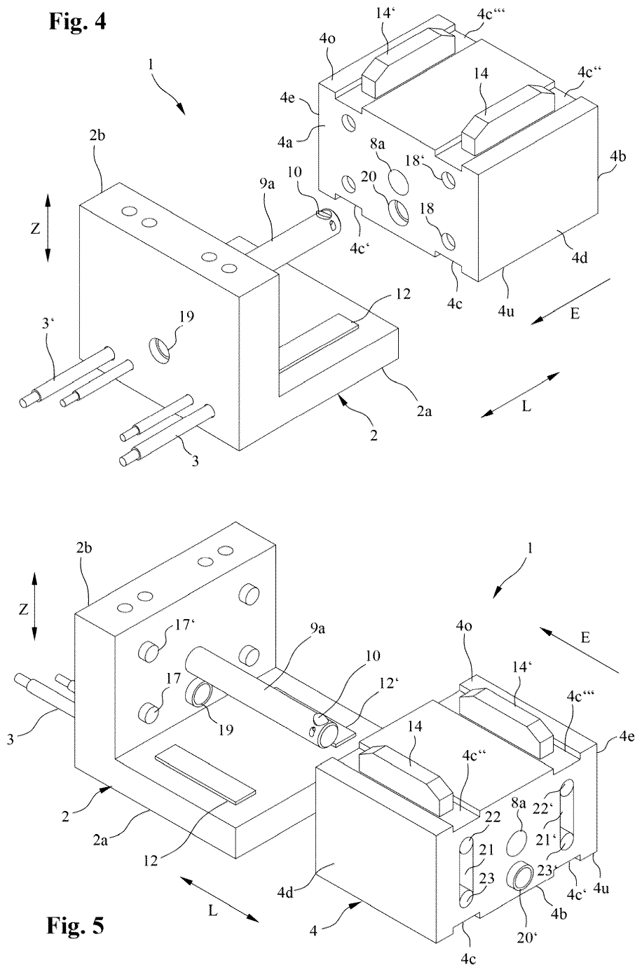

An alternative quick-change connection with an alternative locking mechanism is shown in FIGS. 4 and 5, and differs from that shown in FIGS. 1 to 3 and 6 to 7 and described above essentially by the interchanged arrangement of the locking pin 9 and the locking bore 8, so that primarily the differences are discussed below. The same reference numerals as in the locking mechanism shown in FIGS. 1 to 3 are used for identical or corresponding parts.

In an alternative locking mechanism, a distinctly longer locking pin 9a is provided, which is arranged on the angled face 2b of the base part 2, as can be seen clearly in FIG. 5. On its free end, the locking pin 9a again has a movable locking lug 10a as already described above, which also functions in the same manner, but which is rotated by 180° relative to the locking lug 10 of FIGS. 1 to 3, when viewed from above.

During mounting of the interchangeable part 4, the locking pin 9a is pushed through a locking channel 8a in the interchangeable part 4 that extends in the insertion direction E. The locking pin 9a is sufficiently long for the locking lug 10a to protrude from the locking channel 8a when the interchangeable part 4 is fully inserted, emerges at the rear face 4b facing away from the base part 2, and thus reliably locks the interchangeable part 4 to the base part 2. A certain degree of play is thus enabled in the insertion direction E, since the electrical connection is still ensured, as described in detail below. However, the stop on the interchangeable part 4, which is necessary for the locking lug 10a, can also be designed differently, for example, it can be provided in the interchangeable part 4.

The longer locking pin 9a with the locking channel 8a passing therethrough simultaneously forms an alternative quick-change connection 5a, since the interchangeable part 4 can be guided in the insertion direction E into its locked final assembly position.

The alternative embodiment of the quick-change connection 5a described in FIGS. 4 and 5 has an advantage in that, in the final installed state of the interchangeable part 4, no additional parts of the quick-change connection need be provided and the locking lug 10a can be activated by hand from the outside without any tools, thus further simplifying the replacement of the interchangeable part 4. This alternative quick-change connection 5a is also less affected by contamination due to the abrasion of the sliding contacts 14, 14′.

In order to now be able to establish an electrical connection between the electrical consumer and the conductor line 100, the base part 2 has one connecting contact 12, 12′ each in the longitudinal direction L to the right and left of the connecting element 6. In the assembled state of the base part 2 and the interchangeable part 4, these form an electrical connection with connecting counter-contacts 13, 13′ arranged on the interchangeable part 4, which can be seen clearly in FIG. 3.

The connecting counter-contacts 13, 13′ each run in a channel-shaped recess 4c, 4c′ provided in a bottom 4u of the interchangeable part 4, as in the drawing, on one side of the interchangeable part, which extends over the entire length of the interchangeable part 4 from the face 4a on the base side to the opposite face 4b, in order to be able to be pushed over the connecting contacts 12, 12′ which extend slightly beyond the connection section 2a.

On a side of the interchangeable part 4 opposite the connecting counter-contacts 13, 13′ (in the drawings, a top 40 of the interchangeable part), upwardly extending sliding contacts 14, 14′ are provided, which are intended for electrical connection to the conductor line 100. The sliding contacts 14, 14′ are designed so as to correspond to the connecting counter-contacts 13, 13′ and also run in the channel-shaped recesses 4c″, 4c″′ in the top 40 of the interchangeable part 4, which are opposite the recesses 4c, 4c′.

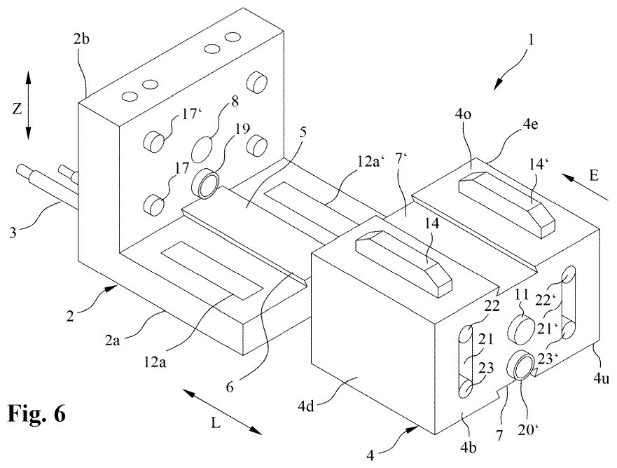

However, if necessary, the connecting contacts 12, 12′ can also optionally be incorporated into the connection section 2a so as to be flush therewith, and so that the channel-shaped recesses 4c, 4c′, 4c′, 4c′″ in the interchangeable part 4 can be omitted, as seen in the alternative embodiment shown in FIG. 6, which is the only difference relative to the variant shown in FIGS. 1 to 3.

The connecting contacts 12, 12′, the connecting counter-contacts 13, 13′, as well as the sliding contacts 14, 14′ can preferably run into the base part 2 in the insertion direction E of the interchangeable part 4. The sliding contacts 14, 14′ can advantageously also run in the longitudinal direction L of the conductor line 100. The insertion direction E preferably runs in the longitudinal direction L. The insertion direction E, however, can also be aligned differently, for example, the interchangeable part 4 can also be designed so that it can be pushed onto base part 2 from the side, i.e., across the longitudinal direction L and preferably across the feed direction Z, or in another alternative embodiment, in the feed direction Z from the top or bottom.

In a simpler embodiment, the sliding contacts 14, 14′ can be electrically connected directly to the connecting counter-contacts 13, 13′ of the interchangeable part so that direct and permanent contact can be established with the connection lines 3, 3′. However, this entails a risk during replacement of the interchangeable part 4 in that the maintenance personnel might touch the sliding contacts 14, 14′ that are connected to the electrical consumer and open at the top, and thus pose a risk of electrical shock.

In order to prevent this, in the advantageous embodiment shown in the drawings, the connecting counter-contacts 13, 13′ and the sliding contacts 14, 14′ are not directly connected to each other, but this only occurs, as described below, upon insertion of the interchangeable part 4 into the base part 2.

For this purpose, the first and second protective contact pins 17, 17′ arranged one above the other on the base side in the height direction relative to the conductor line 100 are provided in the face 2b of the base part 2 so as to be electrically connected to each other, as can be seen in FIGS. 2 and 3, whereas corresponding first and second protective contacts 18, 18′ on the change side, as seen clearly in FIG. 1, are provided on the interchangeable part 4. The protective contacts 18, 18′ are spring-loaded in the face 4a so that the protective contact pins 17, 17′ on the base side engage in the openings of the protective contacts 18, 18′ and can establish electrical contact therewith. The first protective contact 18 is then electrically connected to the connecting counter-contacts 13, whereas the second protective contact 18′ lying thereabove is electrically connected to the sliding contact 14, for example, via the flexible lines shown in FIGS. 1A and 1B.

If the interchangeable part 4 is now inserted into the base part 2, the electrical connection between the electrical connection line 3 and the sliding contact 14 is only established via the connecting contact 13, the connecting counter-contact 14, the first protective contact 18, the first protective contact pin 17, the second protective pin 17′ and the second protective contact 18′, when the interchangeable part 4 is fully inserted into the base part 2.

The connection between the electrical connection line 3′ and the sliding contact 14′ via the connecting contact 13′ and the connecting counter-contact 14 occurs as described above, without the corresponding protective contact pins and the protective contacts being described in detail with reference numerals.

As can be seen clearly in FIG. 1, the interchangeable part 4 has a substantially box-like configuration, the opposing top and bottom being designed symmetrically. The interchangeable part 4 has a second connecting counter-element 7′ at the top, located at the top in FIG. 1, which is opposite the first connecting counter-element 7 of the dovetail connection 5 on the bottom.

The sliding contacts 14, 14′ provided for connection to the conductor line 100 and the connecting counter-contacts 13, 13′ are identical, but are arranged in mirror-image fashion on the bottom or top of the interchangeable part 4.

The connecting counter-contacts 13, 13′ and the sliding contacts 14, 14′ protrude from the connecting counter-contact openings 15, 15′ and the sliding contact openings 16, 16′ provided in the interchangeable part 4, wherein they are pressed outward by pressure elements, which are preferably spring-loaded. As described in more detail below, a dual-acting coil spring 24 is provided for this purpose in FIGS. 1A and 1B. The sliding contacts 14, 14′ are pressed in a feed direction Z against the conductor line 100 and the connecting counter-contacts 13, 13′ are pressed against the connecting contacts 12, 12′ of the base part counter to the feed direction Z, and thus a reliable permanent electrical connection is ensured. Separate pressure elements, in particular springs, arranged on the interchangeable part, can be provided for the connecting counter-contacts 13, 13′ and the sliding contacts 14, 14′. As an alternative, one pressure element 24 or a plurality of pressure elements, for example, springs, can also be provided only between the connecting counter-contacts 13, 13′ and the sliding contacts 14, 14′, which press the connecting counter-contacts 13, 13′ and the sliding contacts 14, 14′ away from each other parallel to the feed direction Z.

Furthermore, the connecting counter-contacts 13, 13′ and the sliding contacts 14, 14′ also have one or more stops not visible in the drawings, which press against the edges of the connecting counter-contact openings 15, 15′ and the sliding contact openings 16, 16′ and prevent the connecting counter-contacts 13, 13′ and the sliding contacts 14, 14′ from falling out of the interchangeable part 4.

Furthermore, the base part 2 also has a extraction opening 19 in its face 2b which is flush with a corresponding additional section opening 20 provided in the interchangeable part 4 on its face 4a. Abraded material penetrating the interchangeable part 4 can be extracted from the connecting counter-contacts 13, 13′ and sliding contacts 14, 14′ from the outside of the base part 2 by means of extraction devices (not shown). This can prevent abrasion from impeding the operation of the connecting counter-contacts 13, 13′ and the sliding contacts 14, 14′, which are always positioned so as to face outward.

Since the interchangeable part 4 is designed symmetrically, when the sliding contacts 14, 14′ moving along the conductor line 100 become worn, the maintenance personnel can simply detach the interchangeable part 4 from base part 2 and insert it again rotated by 180°. The still unused connecting counter-contacts 13, 13′ then form the conducting line contacts provided for connection to the conductor line 100 and are again pressed against the conductor line 100 until they are worn. Only then must a new interchangeable part 4 with unused connecting counter-contacts 13, 13′ and sliding contacts 14, 14′ be inserted. This can also be accomplished quickly and without significant installation expense owing to the simple replaceability. The change option of the interchangeable part 4 enables immediate use without having to immediately obtain a new interchangeable part 4, and therefore significantly increases the system availability, in particular when combined with the fact that the work can be conducted by a trained worker without any additional technical qualifications. A new interchangeable part 4 can then be supplied in timely fashion without any time pressure.

In order to make it easier for the maintenance personnel to inspect the degree to which the sliding contacts 14, 14′ are already worn, the interchangeable part 4 has two viewing openings 21, 21′ formed as elongated holes running in the feed direction Z on its face 2a of the base part or its face 4b, in which a wear indicator 22, 22′ visible from the outside can be seen. The wear indicator 22, 22′ is arranged on the sliding contact 14, 14′ or on a holder accommodating it in the interior of the interchangeable part 4 and moves upward in the viewing openings 19, 19′ as the sliding contacts 14, 14′ become increasingly worn. If the sliding contact 14, 14′ is fully worn, this is indicated by the fact that the wear indicator 22, 22′ lies at the end of the viewing openings 21, 21′ in the direction of the contact line 100.

Corresponding wear indicators 23, 23′ are provided for the connecting counter-contacts 13, 13′.

Since no movement and therefore no additional wear occurs between the connecting contacts 12, 12′ and the connecting counter-contacts 13, 13′ during operation, this electrical connection can also be ensured with worn sliding contacts 14, 14′. As a result, the service life of the interchangeable part 4 in the base part 2 can be effectively doubled, so when that the sliding contact 14, 14′ becomes worn, the interchangeable part 4 need only be rotated in order to use the still unworn connecting counter-contacts 13, 13′ as sliding contacts for an electrically conductive conductor line profile of the conductor line 100.

FIGS. 1A and 1B show a section through the current collector 1 of FIG. 1 in the insertion direction E and parallel to the side walls 2d, 2e through the connecting counter-contact 13 and the sliding contact 14, wherein the interchangeable part 4 in FIG. 1A is shown only partially inserted and in FIG. 1B then fully inserted and locked in the operationally ready and final installed state. The part of the locking pin 9 lying outside of the cross section and accommodated in the base part 2, as well as the undercut arranged in the face 2b, are shown by dashed lines.

As can be seen clearly, the still unused connecting counter-contact 13 and sliding contact 14 are pressed in the feed direction Z toward the connecting contact opening 15 and thus toward the connecting counter-contact 13 or toward the sliding contact opening 16, and thus against the still unengaged conductor line 100, by a pretensioning device in the form of a pretensioned coil spring 24 acting therebetween. The bias of the coil spring 24 is chosen so that the connecting counter-contact 13 and the sliding contact 14 in the unincorporated state of the interchangeable part 4 are pressed completely outward until a stop 25 or 26 of the connecting counter-contact 13 and the sliding contact 14 stop against the inner edge of the connecting counter-contact opening 15 of the sliding contact opening 16. In FIGS. 1A and 1B, this is clearly visible on the sliding contact 14, which is in its fully extended position, whereas the connecting counter-contact 13 lying against the connecting contact 12 is already in a retracted position. During operation, the sliding contact 14 then comes to a stop against the conducting line 100, which is only shown in FIG. 1B, and is then pressed downward in the feed direction Z from its position shown in FIG. 1B and against the coil spring 24.

The stops 25, 26 can also be configured differently in order to limit the extension of the connecting counter-contact 13 and the sliding contact 14 from the interchangeable part 4 or its housing.

Preferably, the current collector 1 can also have a release device which, when the above-described locking mechanism is opened, switches the connecting contacts 12, 12′, 12a, 12a′ to a voltage-free state. For example, for this purpose, a sensor can be provided in the base part 2, which detects whether the locking lug 10 is located in the undercut, for example, inductively or optically, and, if not, the electrical connection between the connecting contacts 12, 12′, 12a, 12a′ and the electrical connection line 3, 3′ is disconnected via a switch provided on the base part 2. This can advantageously ensure that the electrical system of the electrical consumer supplied by the current collector 1 is electrically disconnected from the current collector 1, thereby preventing a health hazard for the operating personnel replacing the interchangeable part.

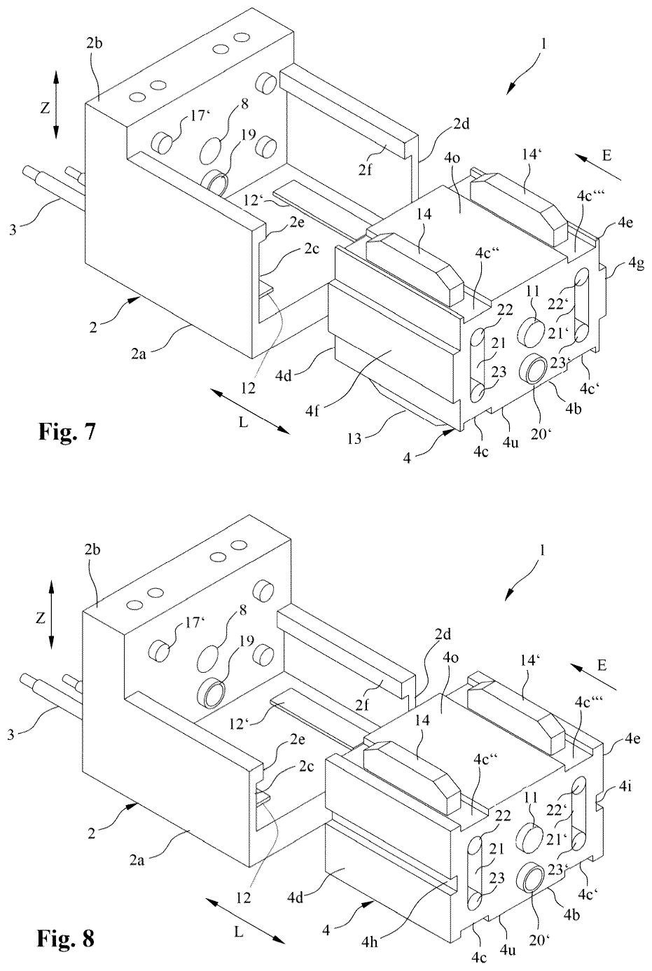

Instead of the configuration of the releasable quick-change connection 5 between the base part 2 and the interchangeable part 4 shown in FIG. 1 as a dovetail connection, FIGS. 7 and 8 show alternative quick-change connections 5b and 5c, in which primarily the differences relative to the quick-change connection 5 from FIGS. 1 to 3 are discussed below. The same reference numerals as in the embodiment shown in FIGS. 1 to 3 are used for identical or corresponding parts.

The variants shown in FIGS. 7 and 8 have quick-change connections 5b and 5c both running in the insertion direction E, which are arranged on opposite side walls 4d, 4e of the interchangeable part 4.

In both cases, the connection section 2a of the base part 2 is provided with side walls 2c, 2d extending upwardly in the feed direction, which preferably abut against the face 2b of the base part 2 and extend same toward the free insertion end in the insertion direction E. At their upper end, the side walls 2c, 2d have inwardly extending connection protrusions 2e, 2f, which form connecting elements of the quick-change connection 5b and 5c.

In the quick-change connection 5b shown in FIG. 7, a protrusion 4f or 4g running in the insertion direction E is preferably provided on the side walls 4d, 4e of the interchangeable part 4 in the feed direction Z, the upper edges of which rest against the connection protrusions 2e, 2f when the interchangeable part 4 is inserted into the base part 2, and provides a sliding guide. The protrusions 4f or 4g thus form connecting counter-elements for the connection protrusions 2e, 2f serving as connecting elements. Advantageously, the protrusions 4f and 4g can be equidistant from the upper and lower sides of the interchangeable part 4, thereby facilitating the rotation of the interchangeable part 4 to replace the connecting counter-contacts 13, 13′ and the sliding contacts 14, 14′.

In the variant shown in FIG. 8, a guide groove 4h or 4i running in the insertion direction E is provided on each of the side walls 4d, 4e of the interchangeable part 4, at the center and in the feed direction Z, which comprise the connection protrusions 2e or 2f and therefore serve as a guide. The connection protrusions 2e and 2f are arranged on correspondingly lower side walls 2c, 2d of the base part 2. The guide grooves 4h and 4i thus form connecting counter-elements for the connection protrusions 2e, 2f serving as connecting elements.

If the connection protrusions 2e and 2f in the finally installed state of interchangeable part 4 are arranged higher or lower in the feed direction Z than an imaginary center line of the side walls 4d, 4e relative to the top and bottom of the interchangeable part 4 on base part 2, then two corresponding guide grooves 4h and 4i are provided on the side walls 4d, 4e of the interchangeable part 4.

The embodiment shown in FIGS. 7 and 8 has the advantage that by pressing the connecting counter-contacts 13, 13′ of the interchangeable part 4 in the feed direction Z against the connecting contacts 12, 12′ of the base part 2, the guide grooves 4h, 4i and the protrusions 4f, 4g of the interchangeable part 4 are pressed against the connection 2e, 2f, thereby improving the feeding of the interchangeable part 4 into the base part 2. These embodiments are also further removed from the connecting counter-contacts 13, 13′ of the interchangeable part 4 and therefore better protected from abrasion.

The connection protrusions 2e, 2f, however, need not be arranged at the end of the side walls 2c, 2d, but can also be arranged at another appropriate site of the side walls 2c, 2d. Optionally, only one of the connection protrusions 2e, 2f can be provided, where only the side wall 2c or 2d is provided on the other side as a guide, or optionally no side wall 2c, 2d at all is provided. The connection protrusions 2e, 2f can optionally also be formed by rods running in the insertion direction E and arranged on the face 2b of the face part 2, which cooperate with the protrusions 4f or 4g or the guide grooves 4h or 4i.

Instead of one protrusion 4f or 4g in FIG. 7, or one guide groove 4h, 4i in FIG. 8, several protrusions and/or guide grooves can also be provided, which cooperate with the connection protrusions 2e, 2f and additional connection protrusions on the base part 2. A combination of the two embodiments in FIGS. 7 and 8 is also advantageously possible.

### REFERENCE NUMERALS

1 Current Collector
2 Base part
2a Connection section of the base part
2b Face of the base part
2c, 2d Side walls of the base part
2e, 2f Connection protrusions
3, 3′ Connection lines of the electrical consumer
4 Interchangeable part
4a, 4b Opposite faces of the interchangeable part
4c, 4c′, 4c″, 4c″′ Groove-like recesses in the interchangeable part
4d, 4e Side walls of the interchangeable part
4f, 4g Protrusions of the interchangeable part
4h, 4i Guide grooves of the interchangeable part
40, 4u Top and bottom of the interchangeable part
5, 5a, 5b, 5c Quick-change connection (including dovetail connection)
6 Connecting element on the base part
7, 7′ First and second connecting counter-element of the interchangeable part
8, 8a Locking opening, locking bore, locking channel
9, 9a Locking pin
10 Locking lug
11 Locking button
12, 12′, 12a, 12a′ Connecting contacts of the base part
13, 13′ Connecting counter-contacts of the interchangeable part
14, 14′ Sliding contacts of the interchangeable part
15, 15′ Connecting counter-contact openings
16, 16′ Sliding contact openings
17, 17 Protective contact pins on the base side
18, 18′ Protective contacts on the change side
19 Extraction opening of the base part
20, 20′ Additional extraction openings of the interchangeable part
21, 21′ Viewing openings, elongated bore
22, 22′ Wear indicators of the sliding contact
23, 23′ Wear indicators of the connecting counter-contacts
24 Pretensioning device, coil spring
25 Stop of the sliding contact
26 Stop of the connecting counter-contact
100 Conductor line
L Longitudinal direction of the conductor line, sliding contacts
E Insertion direction of the interchangeable part into the base part
Z Feed direction of the sliding contact

1-29. (canceled)

30. A current collector with a base part and a replaceable part that can be detachably connected to the base part,
wherein the interchangeable part has at least one first electrically conductive contact for electrical contact with an electrically conductive countercontact,
wherein the base part has an electrical connecting contact and the interchangeable part has an electrical connecting countercontact which can be electrically connected to the electrical connecting contact,
wherein a connection is provided for releasably connecting the base part to the interchangeable part,
wherein at least one connecting element is provided on the base part and at least one corresponding connecting counter-element is provided on the interchangeable part, and
wherein the connection is a plug connection.

31. The current collector according to claim 30, wherein a further connecting counter-element is arranged on the interchangeable part on a side of the interchangeable part opposite the first connecting counter-element and/or a further connecting element is arranged on the base part on a side of the base part opposite the first connecting element.

32. The current collector according to claim 30, wherein the connection extends in an insertion direction of the interchangeable part into the base part.

33. The current collector according to claim 30, wherein the connection has a pin arranged on the base part, which extends through a channel running completely or at least partially through the interchangeable part.

34. The current collector according to claim 33, wherein a locking device is provided for manually, releasable locking of the interchangeable part on the base part.

35. The current collector according to claim 34, wherein the locking device has a locking opening on the base part and a locking pin which can be inserted into the locking opening on the interchangeable part, or vice versa, wherein a movable locking lug is provided on the one part can be inserted into a locking stop on the other part and locked there.

36. The current collector according to claim 35, wherein the locking pin forms the pin of the connection and the locking opening forms the channel of the connection.

37. The current collector according to claim 30, wherein the first contact is pressed toward the counter contact by means of a pressure element arranged on the interchangeable part.

38. The current collector according to claim 30, wherein on a side of the interchangeable part other than the side of the first contact, a second contact which forms the electrical connecting countercontact is provided, wherein the first contact and the second contact are separate parts independent of one another.

39. The current collector according to claim 38, wherein the first contact and the second contact are electrically connected to each other, and/or wherein, when the interchangeable part is connected to the base part, the first contact can be connected to a first protective contact pin, on the base part and the second contact can be connected to a second protective contact pin on the base part, wherein the first and second protective contact pins are electrically connected to each other in or on the base part.

40. The current collector according to claim 39, wherein the second contact is pressed by means of a further pressure element from the interchangeable part in the direction of the connecting contact of the base part.

41. The current collector according to claim 30, wherein an extraction opening is provided in the base part and a corresponding further extraction opening is provided in the exchangeable part for extracting abrasion from the contact or contacts from the exchangeable part.

42. The current collector according to claim 30, wherein the exchangeable part has a housing, wherein the contact or contacts are arranged in the housing and project outwards through a connecting counter-contact opening or contact opening in the housing for contacting the counter-contact and/or the connecting contact of the base part.

43. The current collector according to claim 42, wherein the contact or contacts each have at least one stop abutting against the housing in order to prevent the contact or contacts from falling out of the respective connecting counter-contact opening or contact opening.

44. The current collector according to claim 30, wherein
the connecting contacts, the connecting counter contacts and/or the contacts are aligned in an insertion direction of the interchangeable part into the base part, and/or
the connecting counter contacts and/or the contacts are arranged in channel-shaped recesses of the interchangeable part, and/or
the exchangeable part has viewing openings for wear indicators connected to the connecting counter contacts and/or contacts connected to the connecting counter-contacts and/or contacts are provided, which indicate the degree of wear of the connecting counter-contacts and/or the contacts.

45. The current collector according to claim 30, wherein a release device is provided which, when the locking device is opened, disconnects the connection contacts from the voltage.

46. The current collector according to claim 30, wherein the current collector is attachable to a movable electrical consumer such that the connecting contact of the base part can be connected to an electrical connecting line of the electrical consumer.

47. The current collector according to claim 38, wherein the first contact is a sliding contact, the second contact is a second sliding contact and/or the counter contact is a sliding conductor profile of a sliding conductor along which a movable electrical consumer attached to the current collector can be moved in a longitudinal direction of the sliding conductor.
